(19) United States
(12) Patent Application Publication
(10) Pub. No.: US 2007/0283306 A1
(43) Pub. Date: Dec. 6, 2007

(54) Layout cells, layout cell arrangement, method of generating a layout cell, method of generating a layout cell arrangement, computer program products

(76) Inventors: Matthias Koefferlein, Munich (DE); Burkhard Ludwig, Muenchen (DE)

Correspondence Address: SLATER & MATSIL LLP, 17950 PRESTON ROAD, SUITE 1000, DALLAS, TX, 75252, US

(21) Appl. No.: 11/443,478

(22) Filed: May 30, 2006

(51) Int. Cl. G06F 17/50

(52) U.S. Cl. 716/8

(57) ABSTRACT

A layout cell includes layout cell information including information about at least one component, and a layout cell identifier identifying the layout cell. The layout cell identifier includes geometrical information about the layout cell.

### TECHNICAL FIELD

The invention relates to layout cells, a layout cell arrangement, a method of generating a layout cell, a method of generating a layout cell arrangement and computer program products.

### BACKGROUND

In a modern design system, geometrical layout data are presented in a hierarchical form. In this case, layout blocks are usually grouped into layout cells, which can be placed in the layout as a whole. A layout cell can be transformed and duplicated in this context. The usage of layout cells results, on the one hand, in a reduction of the amount of data that needs to be processed, and, on the other hand, in a partitioning of the resulting layout. The partitioning of a layout allows to process even complex designs by means of abstraction of the design task on different levels of abstraction.

When processing the geometrical data by means of an external program, for example in the “Design Rule Check” or the “Post Processing” in general, it often occurs that the generated hierarchy in the data structure is destroyed, since it may be necessary to address layout cells in different environments differently, for example. This would break the abstraction and the data structure of a layout cell arrangement. The destruction of the generated hierarchy in the data structure may also be referred to as the “generation of variants”. However, it may be desirable to present the results of the processing of the data structure of a layout cell arrangement by the external program in the context of a graphical representation, for example in the context of the plotted layout. It may for example be desirable to display the results of the “Design Rule Check” in a layout editor. In this case, it would be necessary to transform geometrical information from a modified hierarchy back into the “original” hierarchy.

The transformation, also referred to as mapping in the following, of the hierarchy levels is usually carried out using names. It is assumed that a layout cell is denominated in a unique way and that it is possible to conclude to the original hierarchy via the name of the modified hierarchy.

However, it is not always possible to carry out the conclusion in a correct manner. The reason for this may be that layout cell names might have to be modified due to limitations of the file formats used, for example, or that specific layout cells having identical names may occur in the layout in different embodiments (so-called parameterizable layout cells).

Another problem with the mapping based on the layout cell names can be seen in that a geometrical correctness is not guaranteed in this case. The geometry is determined by the instantiation of a layout cell. The name of the layout cell is merely an orientation guide for the user.

### SUMMARY OF THE INVENTION

In accordance with an embodiment of the invention, a layout cell is provided comprising layout cell information comprising information about at least one component, and a layout cell identifier identifying the layout cell, the layout cell identifier comprising geometrical information about the layout cell.

An embodiment of the invention clearly achieves a layout cell, which can be mapped with guaranteed geometrical correctness.

These and other features of the invention will be better understood when taken in view of the following drawings and a detailed description.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a computer device including an integrated circuit layout design tool and an integrated circuit layout verification tool in accordance with an embodiment of the present invention;

FIG. 2 illustrates a diagram showing the back transformation of layout verification data into layout design data in accordance with an embodiment of the present invention;

FIG. 3A illustrates a layout cell arrangement in accordance with an embodiment of the present invention;

FIG. 3B illustrates the layout cell arrangement of FIG. 3A in a graph representation in accordance with an embodiment of the present invention;

FIG. 4A illustrates a modified layout cell arrangement in accordance with an embodiment of the present invention;

FIG. 4B illustrates the modified layout cell arrangement of FIG. 4A in a graph representation in accordance with an embodiment of the present invention;

FIG. 5 illustrates a flow diagram showing an exemplary layout design process in accordance with an embodiment of the present invention;

FIG. 6 illustrates a flow diagram showing an exemplary layout verification process in accordance with an embodiment of the present invention;

FIG. 7 illustrates a flow diagram showing an exemplary method of generating a design layout cell in accordance with an embodiment of the present invention;

FIG. 8 illustrates a flow diagram showing an exemplary method of generating a design layout cell arrangement in accordance with an embodiment of the present invention;

FIG. 9A illustrates a layout cell arrangement in accordance with an embodiment of the present invention; and

FIG. 9B illustrates the layout cell arrangement of FIG. 9A in a graph representation in accordance with an embodiment of the present invention.

### DETAILED DESCRIPTION OF ILLUSTRATIVE EMBODIMENTS

Methods and apparatuses are described herein with respect to integrated circuit manufacturing; however, the techniques described can be applied to the manufacturing and/or design process of any integrated device. Integrated devices include integrated circuits, micromachines, thin film structures such as disc drive heads, gene chips, microelectromechanical systems (MEMS), or any other article of manufacture that is manufactured using lithography techniques.

In one exemplary embodiment of the invention, the layout cell is a layout cell of an electronic circuit, for example a layout cell of an electronic memory circuit, alternatively for example a layout cell of an electronic logic circuit.

The at least one component may be selected from a group of components, e.g. electronic components, consisting of at least one contact, at least one conductor track, at least one electrically non-active component such as at least one alignment marking, at least one resistor, at least one capacitance, at least one inductance, at least one transistor, or at least one memory cell, or any combination of the above mentioned components.

In one exemplary embodiment of the invention, the layout cell identifier comprises at least one hash value of the geometrical information about the layout cell.

In one exemplary embodiment of the invention, the geometrical information about the layout cell is geometrical information in relation to another layout cell.

In one exemplary embodiment of the invention, the layout cell identifier is a unique identifier of the layout cell.

In another exemplary embodiment of the invention, the geometrical information about the layout cell may be geometrical information of at least one of the following characteristics of the layout cell: a position of the layout cell, a displacement of the layout cell, a rotation of the layout cell, and/or a mirroring of the layout cell.

In accordance with another exemplary embodiment of the invention, a layout cell arrangement comprises a plurality of layout cell, each layout cell of the layout cells comprising:

layout cell information comprising information about at least one electronic component that is contained in the layout cell,

layout cell identifier identifying the layout cell,

the layout cell identifier comprising geometrical information about the layout cell.

The layout cells may be hierarchically arranged in the layout cell arrangement. Thus, the hierarchical layout cell arrangement comprises in accordance with one embodiment of the invention at least one parent layout cell and at least one child layout cell.

The geometrical information about a child layout cell may be geometrical information in relation to another child layout cell.

In another exemplary embodiment of the invention, the geometrical information about a child layout cell is geometrical information in relation to a parent layout cell.

Moreover, a plurality of child layout cells may be provided. In this embodiment, at least two child layout cells of the plurality of child layout cells may have the same parent layout cell.

In another exemplary embodiment of the invention, the layout cell identifier is a unique identifier of the respective layout cell.

In yet another exemplary embodiment of the invention, the layout cell identifier comprises at least one hash value of the geometrical information about the respective layout cell.

Furthermore, the geometrical information about the layout cell may be geometrical information of at least one of the following characteristics of the layout cell:

a position of the child layout cell within the parent layout cell,

a displacement of the child layout cell within the parent layout cell with regard to a reference location,

a rotation of the child layout cell within the parent layout cell,

a mirroring of the child layout cell within the parent layout cell.

In accordance with another exemplary embodiment of the invention, a layout cell comprises:

layout cell information comprising information about at least one component,

a layout cell identifier identifying the layout cell,

the layout cell identifier comprising at least one hash value of geometrical information about the layout cell in relation to another layout cell.

In accordance with an exemplary embodiment of the invention, a method of generating a layout cell is provided, comprising:

generating layout cell information comprising information about at least one component,

generating a layout cell identifier identifying the layout cell using geometrical information about the layout cell.

In accordance with an exemplary embodiment of the invention, a method of generating a layout cell arrangement is provided, comprising:

generating at least one parent layout cell,

generating at least one child layout cell of the at least one parent layout cell,

generating a layout cell arrangement identifier identifying the layout cell arrangement using geometrical information about the child layout cell.

In accordance of an embodiment of the methods disclosed, the generating the layout cell arrangement identifier may comprise determining at least one hash value of the geometrical information about the child layout cell.

Furthermore, the determining of the at least one hash value of the geometrical information about the child layout cell may further comprise determining a first partial hash value of the geometrical information about the child layout cell, and determining a second partial hash value of the geometrical information about the parent layout cell and the first partial hash value.

In one embodiment of the invention, the determining of the at least one hash value is carried out using a one-way hash function.

In one embodiment of the invention, the at least one hash value is a vector having at least two dimensions.

In accordance with an exemplary embodiment of the invention, a method of generating a layout cell arrangement is provided, comprising:

generating at least one parent layout cell,

generating at least one child layout cell of the at least one parent layout cell,

generating a layout cell arrangement identifier identifying the layout cell arrangement using geometrical information about the child layout cell, the at least one parent layout cell referencing the at least one child layout cell by means of a transformation operator.

The transformation operator may be a commutative transformation operator and/or an associative transformation operator.

Furthermore, the transformation operator may comprise at least one of the following operations: summation, exclusive-or, multiplication.

In accordance with an exemplary embodiment of the invention, a method of generating a layout cell arrangement is provided, comprising:

generating at least one parent layout cell,

generating at least one child layout cell of the at least one parent layout cell,

generating a layout cell arrangement identifier identifying the layout cell arrangement using geometrical information about the child layout cell, the at least one parent layout cell referencing the at least one child layout cell using an associative data structure.

In accordance with an exemplary embodiment of the invention, a method of determining a layout cell identifier for a layout cell is provided, comprising

hashing geometrical information of the layout cell, thereby generating a hash value.

In accordance with exemplary embodiments of the invention, computer program products of generating a layout cell and of generating layout cell arrangements are provided that, when being executed by means of a processor, comprise the features of the methods as they are described above and as they will be described in more detail below.

The various embodiments of the invention may be implemented in software, i.e. by means of one or a plurality of correspondingly configured computer programs, in hardware i.e. by means of one or a plurality of correspondingly configured electronic circuits, or in any arbitrary hybrid form, i.e. in any parts partially in software and partially in hardware.

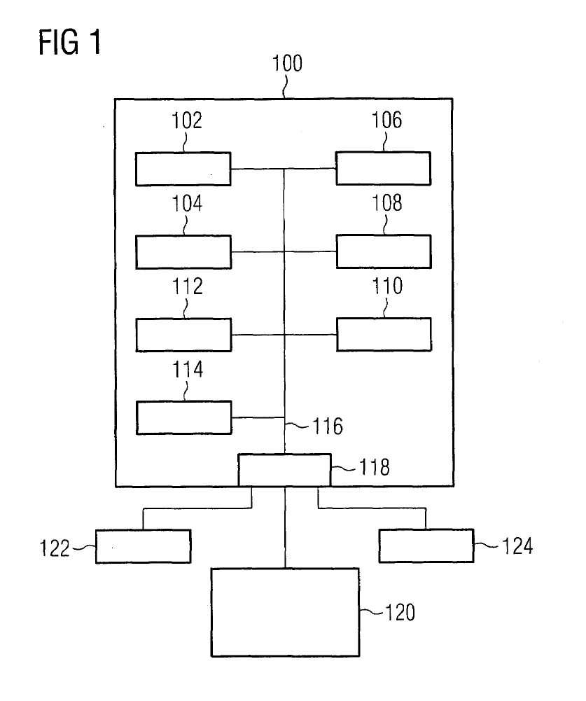

FIG. 1 illustrates a computer device 100 in accordance with an embodiment of the present invention, comprising a central processing unit (CPU) 102 and a graphic processing unit 104. The processing units 102, 104 both have at least one microprocessor. The central processing unit 102 is used and configured for carrying out the general tasks and the optional graphic processing unit 104 is used and configured for carrying out the special graphic calculation oriented tasks, e.g. used in a computer-aided (CAD) layout design process for determining the layout of an integrated circuit for subsequent manufacture of the developed integrated circuit on a wafer, e.g. a semiconductor wafer, e.g. a silicon wafer.

The computer device 100 may be a personal computer or a workstation, in alternative embodiments of the invention, a plurality of computers that are connected to one another, e.g. by means of a local area network (LAN) or a wide area network (WAN).

The computer device 100 in accordance with one embodiment of the invention has a read only memory (ROM) 106 storing the booting routines of the computer device 100. Furthermore, a plurality of random access memories (volatile as well as non-volatile) (RAM) is provided, in accordance with one embodiment of the invention comprising a first random access memory 108 storing the program code of the computer programs of the respective layout processes that will be described in more detail below, and a second random access memory 110 storing the data used by the computer programs of the respective layout processes that will be described in more detail below

Moreover, the computer device 100 in accordance with one embodiment of the invention has one or a plurality of layout design tools 112 (as desired) providing the respective layout design processes that will be described in more detail below and one or a plurality of layout verification tools 114 (as desired) providing the respective layout verification processes that will be described in more detail below.

The components of the computer device 100 described above are connected to each other by means of one or a plurality of data busses and control busses 116.

Via one or a plurality of input/output interfaces 118, which are also provided in the computer device 100, the computer device 100 is connected to several peripheral units, e.g. a display 120, a keypad 122 and/or a computer mouse 124. It should be noted that any other input devices (such as trackball, touchscreen, etc.) or output devices (such as printer, loudspeaker, etc.) can be provided in an alternative embodiment of the invention.

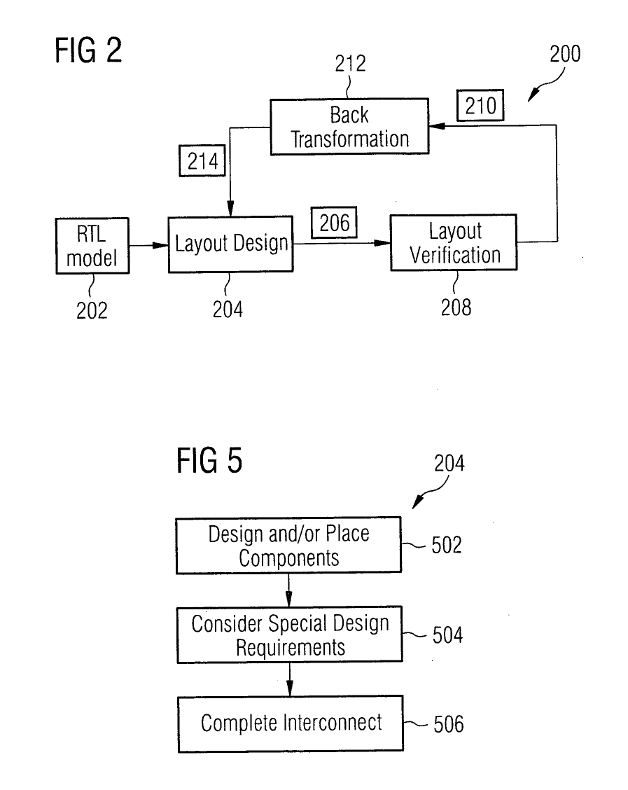

When developing an integrated circuit, one entry point into the design flow is an RTL (register transistor logic) model 202 (see block diagram 200 in FIG. 2) of an electronic design or system. The physical implementation of the electronic design can then be an integrated circuit (IC), part of an IC, or multiple ICs on a circuit board.

The RTL model 202 describes the function of the electronic system using a Hardware Description Language (HDL) such as Verilog or VHDL. The RTL model 202 may be either directly written by a system designer, or generated from a behavioural model using a behavioural synthesis. In addition, the RTL model 202 may be extracted directly from internal data structures of a behavioural model without undergoing RTL model 202 construction.

Using the RTL model 202 as input data, a layout design process 204 is carried out, which will be described in more detail below. The layout design process 204 is carried out by the one or plurality of layout design tools 112 in a layout design environment. As a result of the layout design process 204, exported layout design data (e.g. a layout design file) 206 is provided by the one or plurality of layout design tools 112.

The exported layout design data 206 are input into a layout processing tool, e.g. into a layout verification process 208, which will be described in more detail below. The layout verification process 208 is carried out by the one or plurality of layout verification tools 114.

In one embodiment of the invention it is assumed that one result of the layout verification process 208, also referred to as layout verification result data 210 (e.g. a layout verification result file), should be fed back into the layout design process 204. Furthermore, it is assumed that the layout verification process 208 destroys or at least modifies at least some of the structure, e.g. hierarchical structure, of the exported layout design data 206 so that the layout verification result data 210 cannot be directly processed again by the one or plurality of layout design tools 112.

Therefore, a back transformation 212 is provided in order to transform the layout verification result data 210 into a format that can be processed by the one or plurality of layout design tools 112.

By way of example, it may be necessary to map the hierarchies of the layout cell instances of a plurality of layout cells, generally speaking, the relationship between several layout cell instances of a plurality of layout cells. Only if the format of the data that is input into the one or plurality of layout design tools 112 is compatible, the user of the one or plurality of layout design tools 112 can view the data in a graphical presentation on the display 120 and is in the position to process the presented data in a convenient manner using a “CAD” tool, namely the one or plurality of layout design tools 112.

Thus, the back transformation 212 uses the layout verification result data 210 as its input and maps it to a transformed layout verification result data 214, which is then input into the one or plurality of layout design tools 112, in other words into the layout design process 204.

As an example, the layout verification result data 210 are data that result from a Design Rule Check that is carried out in the layout verification process 208. The results from the Design Rule Check should be presented in the layout editor of the one or plurality of layout design tools 112.

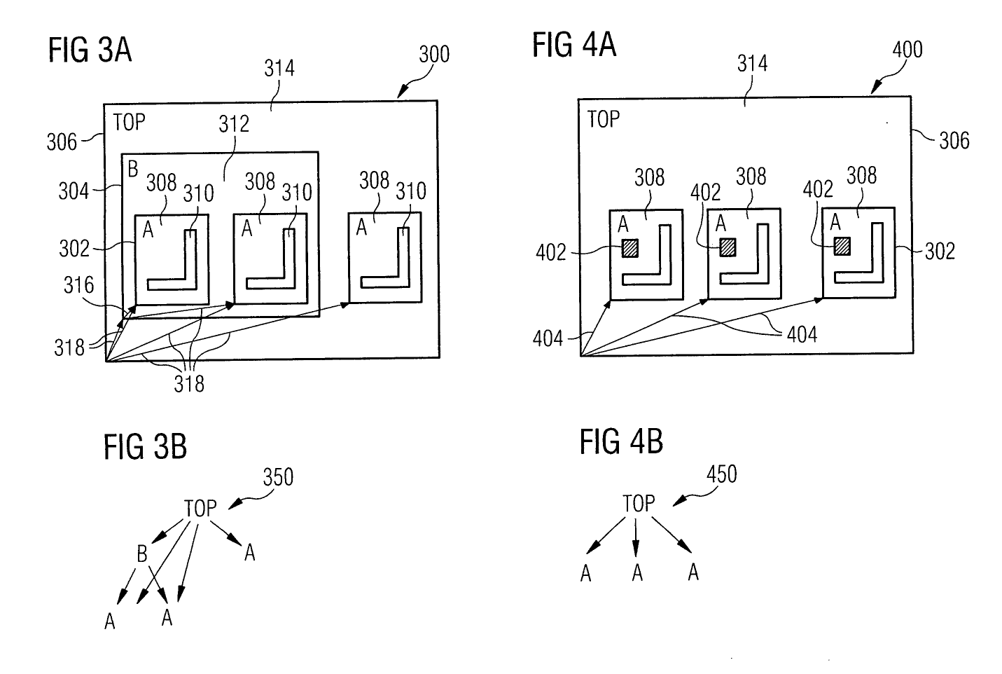

FIG. 3A illustrates an example of a layout cell arrangement 300 comprising a hierarchy of a plurality of layout cell instances. A layout cell instance is a concrete instantiation of a layout cell. In other words, a layout cell is described using the general shape of the layout cell and the components contained therein including parameters, with which it is possible to vary the concrete length, width, generally speaking, e.g. the size of a respectively instantiated layout cell, i.e. the layout cell instance.

In one embodiment of the invention, the layout cell arrangement 300 comprises a plurality of hierarchy levels, e.g. three layout cell hierarchy levels 302, 304, 306, each layout cell hierarchy level 302, 304, 306 comprising at least one layout cell instance.

Each layout cell instance of the plurality of layout cell instances comprises a description of at least one component, e.g. of at least one electronic component, that is contained in the layout cell instance, the shape of the at least one component, the arrangement of the at least one component within the layout cell instance, the respective characteristic, e.g. electrical characteristics, of the at least one component.

As mentioned, the at least one component can be a non-electronic component or an electronic component. It should be noted that also one or more non-electronic components and one or more electronic component can be provided in a layout cell instance.

By way of example, the non-electronic component may be an electric contact or a conductor track or an electrically non-active component such as an alignment marking.

The at least one electronic component in a layout cell can be one or more of the following electronic components:

at least one resistor,

at least one capacitance,

at least one inductance,

at least one transistor,

at least one memory cell,

or any combination of the above mentioned components.

In one embodiment of the invention, the bottommost layout cell hierarchy level 302 of the layout cell arrangement 300 has three first level layout cell instances 308, each of them having one transistor 310 being arranged in the first level layout cell instance 308 and having an L-shape. Each of the first level layout cell instances 308 further comprises the information about the position of the transistor 310 within the body of the first level layout cell instance 308. The first level layout cell instances 308 are also denoted with the symbol “A”.

Furthermore, the middle layout cell hierarchy level 304 has one second layout cell instance 312 that includes two of the first level layout cell instances 308 being arranged next to each other. The second layout cell instance 312 has assigned the information that it includes two first layout cell instances 308 and the spatial information about their arrangement or location within the body of the second level layout cell instance 312 (in FIG. 3A symbolized by first arrows 316). In this embodiment of the invention, the spatial information is indicated using the left bottom point of the second layout cell instance 312 as a reference location (in other words as the origin coordinate of the second layout cell instance 312) and using a relative spatial information indication. The second level layout cell instance 312 is also denoted with the symbol “B”.

The uppermost layout cell hierarchy level 306 has one third layout cell instance 314 that includes the second layout cell instance 312 and the third of the first layout cell instances 308 that has not been grouped into the second layout cell instance 312, the second layout cell instance 312 and the third of the first layout cell instances 308 being arranged next to each other. The third layout cell instance 314 has assigned the information that it includes the second layout cell instance 312 and the third of the first layout cell instances 308 and the spatial information about their arrangement or location within the body of the third level layout cell instance 314 (in FIG. 3A symbolized by second arrows 318). In this embodiment of the invention, the spatial information is indicated using the left bottom point of the third layout cell instance 314 as a reference location (in other words as the origin coordinate of the third layout cell instance 314) and using a relative spatial information indication. The third level layout cell instance 314 is also denoted with the symbol “TOP”.

FIG. 3B shows a layout cell tree 350 of the layout cell arrangement 300 of FIG. 3A. The layout cell tree 350 has three layers corresponding to the above described levels, wherein the third level layout cell instance 314 “TOP” represents the root node of the layout cell tree 350. The second level layout cell instance 312 “B” and the third of the three first level layout cell instances 308 “A” are located in the middle layer of the layout cell tree 350. The first and second of the first level layout cell instances 308 “A” are located in the bottommost layer of the layout cell tree 350. The relationship between the level layout cell instances 308, 312, 314 is symbolized by means of arrows, wherein each arrow (also referred to as a directed edge) means that the level layout cell instance being located at the beginning of the arrow includes the respective level layout cell instance being located at the end of the arrow.

The layout cell arrangement 300 of FIG. 3A is, as described above, one example of the exported layout design data 206.

FIG. 4A illustrates an example of a modified layout cell arrangement 400 that corresponds to the layout cell arrangement 300 of FIG. 3A, wherein the middle layout cell hierarchy level 304 with the second level layout cell instance 312 “B” has been removed. Except for this difference, the modified layout cell arrangement 400 is similar to the layout cell arrangement 300 of FIG. 3A and therefore, the repeated description of the identical elements is omitted here. The modified layout cell arrangement 400 of FIG. 4A is, as described above, one example of the layout verification result data 210.

Furthermore, the first level layout cell instances 308 “A” include information (in FIG. 4A symbolized by means of a rectangular 402) that are subject to the back transformation 212 and should be mapped such that this information and therewith also the entire layout verification result data 210 can, for example, be processed by means of the one or a plurality of layout design tools 112. It should be noted that the spatial information about the arrangement of the first level layout cell instances 308 within the second level layout cell instance 312 and the spatial information about the arrangement of the second level layout cell instance 312 within the third level layout cell instance 314 has been replaced by spatial information about the arrangement of the three first level layout cell instances 308 within the third level layout cell instance 314 (in FIG. 4A symbolized by means of third arrows 404). In this embodiment of the invention, the spatial information is indicated using the left bottom point of the third layout cell instance 314 as a reference location (in other words as the origin coordinate of the third layout cell instance 314) and using a relative spatial information indication.

FIG. 4B shows a modified layout cell tree 450 of the modified layout cell arrangement 400 of FIG. 4A. The modified layout cell tree 450 now only has two layers corresponding to the above described levels (note that the middle layer has been removed), wherein the third level layout cell instance 314 “TOP” represents the root node of the modified layout cell tree 450. The three first level layout cell instances 308 “A” are located in the uppermost layer of the modified layout cell tree 450. The relationship between the level layout cell instances 308, 314 is symbolized by means of arrows, wherein each arrow (also referred to as a directed edge) means that the level layout cell instance being located at the beginning of the arrow includes the respective level layout cell instance being located at the end of the arrow.

FIG. 5 shows an exemplary embodiment of the layout design process 204 in accordance with the present invention.

As an example, a step including designing and placing the components and the layout cell instances is carried out (step 502), wherein they are created and placed as required using a predetermined floorplan and in accordance with layout guidelines provided for the respective integrated circuit to be designed and the respective technology used for manufacturing the integrated circuit.

Subsequently, a step of considering special design requirements is carried out (step 504), wherein critical and methodology elements are considered and the placement of the layout cell instances is refined, for example.

Finally, the interconnections between the layout cell instances are completed (step 506).

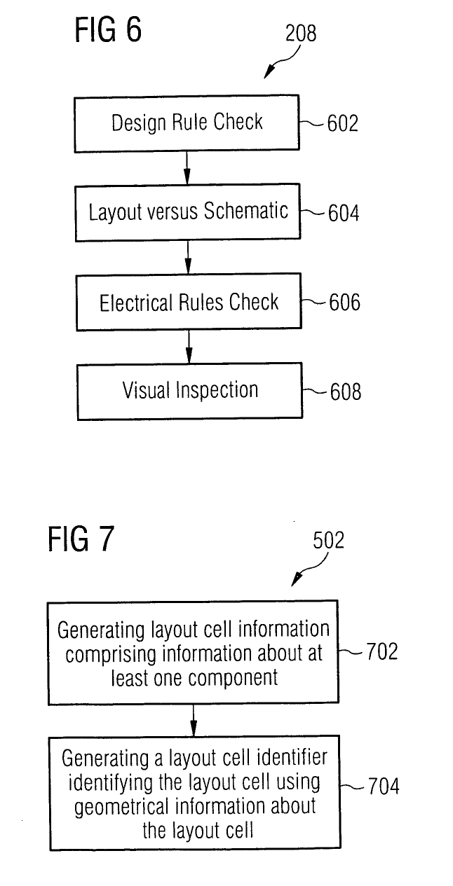

FIG. 6 shows an exemplary embodiment of the layout verification process 208 in accordance with the present invention.

As an example, a step including Design Rules Check (DRC) is carried out by means of the one or a plurality of layout verification tools 114. The design rule verification step (step 602) checks that all polygons of the layout cell instances and all layers from a predefined and stored layout database meet all of the predefined manufacturing process rules. The design rules define the limits of a manufacturable design including width and space rules. In one embodiment of the invention, several methodology, connectivity and guideline rules are checked as well.

Following the DRC, a Layout versus Schematic verification step (LVS) (step 604) is carried out including checking that the design is connected correctly. The schematic is the reference circuit and the layout is checked against it. By way of example, the following is verified:

Electrical connectivity of all signals, including input, output and power signals to their corresponding devices (e.g. electronic components).

Device sizes: transistor width and length, resistor sizes, capacitor sizes.

Identification of extra components and signals that have not been included in the schematic, e.g. floating nodes.

Next, optionally, an Electrical Rules Check (step 606) is carried out. Electrical rules checked in this step may be limited to errors in connectivity or device connection, including, for example:

Unconnected, partly connected, or extra devices;

Disabled transistors;

Floating nodes;

Short circuits;

Special checks not checked elsewhere, e.g. antenna rules.

Then, the design may be plotted and visually inspected (step 608). A visual check is carried out against layout guidelines and special rules.

FIG. 7 illustrates a flow diagram showing an exemplary method of generating a design layout cell in accordance with an embodiment of the present invention.

In this embodiment of the invention, the step including designing and placing the components, e.g. the electronic components, and the layout cell instances (step 502) comprises generating layout cell information comprising information about at least one component (step 702) followed by generating a layout cell identifier identifying the layout cell using geometrical information about the layout cell (step 704).

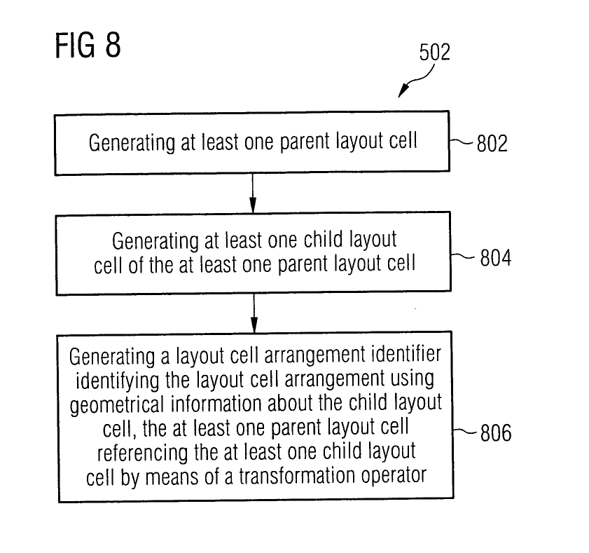

FIG. 8 illustrates a flow diagram showing an exemplary method of generating a design layout cell arrangement in accordance with an embodiment of the present invention, wherein at least one parent layout cell is generated (step 802). Furthermore, at least one child layout cell, in one embodiment of the invention, a plurality of child layout cells, of the at least one parent layout cell is generated (step 804). Next, a layout cell arrangement identifier is generated identifying the layout cell arrangement using geometrical information about the child layout cell, the at least one parent layout cell referencing the at least one child layout cell by means of a transformation operator (step 806).

In one embodiment of the invention, the geometric correctness of the layout cell instances even after the mapping is achieved by identifying a layout cell not simply using a name, but by using a “flat” set of the layout cell instances with regard to the top layout cell instance, in other words with regard to the root layout cell instance. In this case, a geometric information can be directly mapped from the layout cell instance of the modified layout cell arrangement 400 into the corresponding layout cell arrangement 300 of the original hierarchy during the back transformation 212. The result of the mapping describes the same information on the level of the chip layout and guarantees the geometrically correct mapping. This cannot be guaranteed with a pure name-based assignment of the layout cells.

In another embodiment of the invention, in addition to the embodiment described above, a possible ambiguity of the assignment of the layout cells may further be prevented by using a unique assignment of one or a plurality of child layout cell instances to its corresponding parent cell instance. From a unique mapping of a child cell, a unique mapping of parent cells can be deduced. A parent layout cell instance is a layout cell instance that contains one or a plurality of layout cell instances, which are also referred to as child layout cell instances. As an example, the second level layout cell instance “B” 312 is a child layout cell instance of the third level layout cell instance “TOP” 314.

In this way, the binding by means of cell names having the disadvantages as described above can be prevented.

In one exemplary embodiment of the invention, this is achieved using a method enabling a fast finding of layout cells with identical (flat) instantiations. In this case, it should be prevented to flatten the cell instances explicitly, since this would result in a large amount of data in a common depth of the layout cell hierarchies, in other words of the layout cell trees, which usually comprise up to several tens of hierarchy levels, e.g. up to about 10 to about 30 hierarchy levels.

In one exemplary embodiment of the invention, the implementation is based on a specific hash function, which can be implemented very efficiently for reducing the search space and on an exact comparison of the (implicitly flattened) instantiation of the layout cells, wherein only a small number of false attempts occur due to the pre-selection using the hash value that has been generated using the hash function that will be described in more detail below.

It should be mentioned that any other function having a similar effect with regard to the geometrically correct mapping can be used in alternative embodiments.

In one embodiment of the invention, the order of the layout cell instances in the layout cell arrangement and in the modified layout cell arrangement, in which they are handled during the comparison, is the same.

This can be achieved, for example, by using the hash function that will be described in more detail below or by additionally providing and carrying out a sorting criterion, an example of which will also be described in more detail below.

By way of example, the layout cell instances may first be ordered according to their x-position with regard to the root layout cell instance or with regard to a predetermined coordinate system (they may be ordered according to increasing x-position values or according to decreasing x-position values, for example). Then, the layout cell instances having the same x-position value may further be ordered according to their y-position with regard to the root layout cell instance or with regard to the predetermined coordinate system (they may be ordered according to increasing y-position values or according to decreasing y-position values, for example). Then, the layout cell instances having the same x-position value and the same y-position value may further be ordered according to their rotation value with regard to the predetermined coordinate system (they may be ordered according to clockwise rotation values or according to counter-clockwise rotation values, for example). Furthermore, the layout cell instances having the same x-position value, the same y-position value and the same rotation value may further be ordered according to their mirroring value.

Having ordered the layout cell instances in a unique way, any hash function can be used, for example secure hash functions such as MD5 or SHA-1.

Furthermore, it should be noted that any kind of associative data structure may be used in accordance with one embodiment of the invention, in which case, e.g. fast matching algorithms may be provided such as a binary search algorithm in a binary tree data structure.

Now, a method for efficiently calculating a hash value of a hierarchically organised data set, e.g. the hierarchical presentation of geometry data for chip designs, in other words, e.g. layout cell arrangement data, will be described in more detail.

Hash values, also referred to as checksums, are to be understood for example as shortened representations of complex data sets. They form the basis of many algorithms for efficient pattern recognition of consistency checking as well as for associative data structures in the form of so called hash maps. A hash value is uniquely assigned to a data set, but not necessarily vice versa. The efficiency, with which the hash value can be calculated, is an important feature of the quality of the said algorithms. Usually, no specific requirements exist for the hash value itself. However, the hash value should strongly vary in the object room that is taken into account in order to distinguish between different configurations as efficiently as possible.

In one embodiment of the invention, a hash function is provided that describes the geometry of a layout and not the organisation such as hierarchy, order of storing the objects (“flat” geometric equivalency), etc.

In the following, a hierarchically organised data set is to be understood a structure having the following characteristics:

A set of objects G(i) is organized in a “cell” C, i.e.

C=G(1), . . . , G(n).

A cell can, in addition to reference objects, also reference further cells (“child cells”) via a transformation operator, i.e.

C=G(1), . . . , G(n), T(1)*C(1), . . . , T(m)*C(m).

One of the cells will not be referenced further; this is the initial cell (“Top cell”) of the layout cell tree.

The expanded (“flat”) representation of a cell C is obtained by replacing the child cell instances of a cell by their objects and by applying the corresponding transformation to each object. This method may be repeated in a recursive manner until the respective cell has no child cell instances anymore. The result of this method is a set of objects F(1), . . . , F(p), which represents the same information as the hierarchical representation.

The hierarchical representation is mainly used for the data reduction: object sets, which differ from one another only by means of a transformation, can be kept in the same cell, which is then instantiated multiple times with different transformations.

The calculation of a hash value over such a hierarchically represented object set should be independent from the hierarchical representation. The algorithm should provide the same hash value, independent from whether the object set is provided in a hierarchical representation or in the equivalent flat representation, i.e.

H(C)=H(F(1), . . . , F(p)).

In one embodiment of the invention, a further limitation is that the hash value should be independent from the order of the objects, i.e.

H(G(1), G(2))=H(G(2), G(1)).

A more efficient method can be defined in that the hierarchy tree is interpreted as a bracketed arithmetic expression in a specific space.

In order to achieve this, a hash value is used, on which an operation “+” is defined such that:

H(G(1), G(2))=H(G(1))+H(G(2)).

Furthermore, a mapping of the transformations in the object space to the transformations of the hash values is defined as follows:

T→U, such that

H(T*G)=U*H(G).

Moreover, a representation for the transformation U is selected, for which an associativity holds true, i.e.

U*(H(1)+H(2))=U*H(1)+H(2).

Thus, the calculation of a hash value for a layout cell can be carried out in a recursive manner according to the following equation:

H(C)=H(G(1))+ . . . +H(G(n))+U(1)*H(C(1))+ . . . +U(m)*H(C(m))

In this case, U(1) corresponds to the transformation T(1) in the hash space.

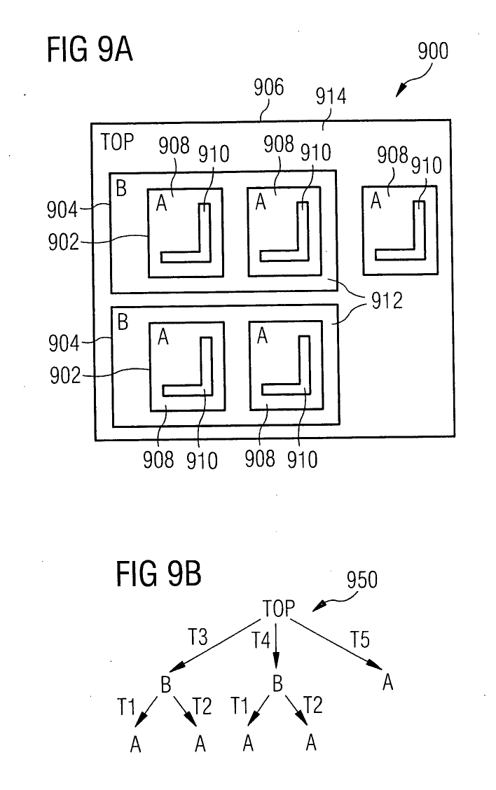

FIG. 9A shows a layout cell arrangement 900 in accordance with another embodiment of the invention which is used for illustrating how the hierarchy of the layout cell arrangement 900 is mapped to an arithmetic expression.

FIG. 9A illustrates an example of a layout cell arrangement 900 comprising a hierarchy of a plurality of layout cell instances.

In this embodiment of the invention, the layout cell arrangement 900 comprises a plurality of hierarchy levels, e.g. three layout cell hierarchy levels 902, 904, 906, each layout cell hierarchy level 902, 904, 906 comprising at least one layout cell instance.

Each layout cell instance of the plurality of layout cell instances comprises a description of at least one component, the shape of the at least one component, the arrangement of the at least one component within the layout cell instance, the respective characteristics of the at least one component.

The at least one component in a layout cell can be one or more of the following electronic components:

at least one contact,

at least one conductor track,

at least one electrically non-active component,

at least one alignment marking,

at least one resistor,

at least one capacitance,

at least one inductance,

at least one transistor,

at least one memory cell,

or any combination of the above mentioned components.

In this embodiment of the invention, the bottommost layout cell hierarchy level 902 of the layout cell arrangement 900 has five first level layout cell instances 908, each of them having one transistor 910 being arranged in the first level layout cell instance 908 and having an L-shape. Each of the first level layout cell instances 908 further comprises the information about the position of the transistor 910 within the body of the first level layout cell instance 908. The first level layout cell instances 908 are also denoted with the symbol “A”.

Furthermore, the middle layout cell hierarchy level 904 has two second layout cell instances 912, each of them including two of the first level layout cell instances 908 being arranged next to each other in the same manner. The second layout cell instances 912 have assigned the information that it includes two first layout cell instances 908 and the spatial information about their arrangement or location within the body of the second level layout cell instances 912. In this embodiment of the invention, the spatial information is indicated using the left bottom point of the respective second layout cell instance 912 as a reference location (in other words as the origin coordinate of the respective second layout cell instance 912) and using a relative spatial information indication. The second level layout cell instance 912 is also denoted with the symbol “B”.

The uppermost layout cell hierarchy level 906 has one third layout cell instance 914 that includes the second layout cell instances 914 and the fifth of the first layout cell instances 908 that has not been grouped into the second layout cell instances 912, the second layout cell instances 912 and the fifth of the first layout cell instances 908 being arranged next to each other. The third layout cell instance 914 has assigned the information that it includes the two second layout cell instances 912 and the fifth of the first layout cell instances 908 and the spatial information about their arrangement or location within the body of the third level layout cell instance 914. In this embodiment of the invention, the spatial information is indicated using the left bottom point of the third layout cell instance 914 as a reference location (in other words as the origin coordinate of the third layout cell instance 914) and using a relative spatial information indication. The third level layout cell instance 914 is also denoted with the symbol “TOP”.

FIG. 9B shows a layout cell tree 950 of the layout cell arrangement 900 of FIG. 9A. The layout cell tree 950 has three layers corresponding to the above described levels, wherein the third level layout cell instance 914 “TOP” represents the root node of the layout cell tree 950. The second level layout cell instances 912 “B” and the fifth of the five first level layout cell instances 908 “A” are located in the middle layer of the layout cell tree 950. The first to fourth of the first level layout cell instances 908 “A” are located in the bottommost layer of the layout cell tree 950. The relationship between the level layout cell instances 908, 912, 914 is symbolized by means of arrows, wherein each arrow (also referred to as a directed edge) means that the level layout cell instance being located at the beginning of the arrow includes the respective level layout cell instance being located at the end of the arrow. A respective transformation operator T(1), T(2), T(3), T(4), T(5) that is assigned to a respective arrow is also shown in FIG. 9B.

The mapping and thus the calculation of the hash value is carried out using the following equation:

H(TOP)=U3*H(B)+U4*H(B)+U5*H(A), wherein

H(B)=U1*H(A)+U2*H(A)

It should be noted that in this embodiment it is only necessary to evaluate the expression that represents the layout cell instance “B” once.

An efficient implementation of the method becomes possible if the cells are present in a “bottom-up”-order (i.e. the child layout cells before their parent layout cells). In this case, the hash value can be calculated and buffer-stored for a layout cell instance. When calculating the hash value of the parent layout cells the hash values of the child layout cells can directly be used without the need of a new calculation of them.

The calculation of the hash value is in this case linearly dependent on the number of objects, independent from their hierarchical organization and in particular independent from how high the degree of compression of the hierarchical representation is.

A specific implementation which is very suitable for the application with geometric tasks in the technical field of chip layouts, uses the following mappings:

Hash values are two dimensional vectors (x, y). The addition is defined as usual: H=H(1)+H(2)=(x(1)+x(2), y(1)+y(2)).

The arithmetic used is an integer arithmetic taking signs into account and having a predetermined bit width (modulo 2̂32, for example).

Transformations are geometric transformations such as mirroring, translation, rotation) with a limitation to a rotation by multiples of 90 degrees. The same transformations are used in the hash space (U=T).

This specific implementation enables a very efficient implementation in a 32 bit integer arithmetic.

For the back transformation 212, the cells having a desired hash value are searched.

In one embodiment of the invention, an iterative algorithm is provided, in which ambiguities are solved by means of an analysis of the relationships of the child layout cells. If one child layout cell is uniquely assigned to another child layout cell, then their parent layout cells are also uniquely assigned to one another, if the child layout cells can be uniquely assigned to a parent layout cell. In an alternative embodiment of the invention, a name of a respective layout cell may also be provided and may be used in order to solve ambiguities. However, in these embodiments of the invention, the geometric correctness is guaranteed in contrast to the usage of a purely name-based assignment.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A layout cell, comprising:
layout cell information comprising information about at least one component; and
a layout cell identifier identifying the layout cell, the layout cell identifier comprising geometrical information about the layout cell.

2. The layout cell as claimed in claim 1, wherein the at least one component comprises an electronic component.

3. The layout cell as claimed in claim 1, wherein the layout cell comprises a layout cell of an electronic circuit.

4. The layout cell as claimed in claim 3, wherein the layout cell comprises a layout cell of an electronic memory circuit.

5. The layout cell as claimed in claim 3, wherein the layout cell comprises a layout cell of an electronic logic circuit.

6. The layout cell as claimed in claim 1, wherein the at least one component comprises selected from the group of electronic components consisting of:
at least one contact;
at least one conductor track;
at least one electrically non-active component;
at least one alignment marking;
at least one resistor;
at least one capacitance;
at least one inductance;
at least one transistor;
at least one memory cell; and
any combination of the above mentioned components.

7. The layout cell as claimed in claim 1, wherein the layout cell identifier comprises at least one hash value of the geometrical information about the layout cell.

8. The layout cell as claimed in claim 1, wherein the geometrical information about the layout cell comprises geometrical information in relation to another layout cell.

9. The layout cell as claimed in claim 1, wherein the layout cell identifier comprises a unique identifier of the layout cell.

10. The layout cell as claimed in claim 1, wherein the geometrical information about the layout cell comprises geometrical information of at least one of the following characteristics of the layout cell:
a position of the layout cell;
a displacement of the layout cell;
a rotation of the layout cell; and
a mirroring of the layout cell.

11. A layout cell arrangement, comprising:
a plurality of layout cells, each layout cell of the layout cells comprising:
layout cell information comprising information about at least one component; and
a layout cell identifier identifying the layout cell, the layout cell identifier comprising geometrical information about the layout cell.

12. The layout cell arrangement as claimed in claim 11, wherein the layout cells are hierarchically arranged in the layout cell arrangement that comprises at least one parent layout cell and at least one child layout cell.

13. The layout cell arrangement as claimed in claim 12, wherein the geometrical information about a child layout cell comprises geometrical information in relation to another child layout cell.

14. The layout cell arrangement as claimed in claim 12, wherein the geometrical information about a child layout cell comprise geometrical information in relation to a parent layout cell.

15. The layout cell arrangement as claimed in claim 14, further comprising a plurality of child layout cells, at least two child layout cells of the plurality of child layout cells being child layout cells of the same parent layout cell.

16. The layout cell arrangement as claimed in claim 11, wherein the layout cell identifier comprises a unique identifier of the respective layout cell.

17. The layout cell arrangement as claimed in claim 11, wherein the layout cell identifier comprises at least one hash value of the geometrical information about the respective layout cell.

18. The layout cell arrangement as claimed in claim 11, wherein the geometrical information about the layout cell comprises geometrical information of at least one of the following characteristics of the layout cell:
a position of the child layout cell within the parent layout cell;
a displacement of the child layout cell within the parent layout cell with regard to a reference location;
a rotation of the child layout cell within the parent layout cell; and/or
a mirroring of the child layout cell within the parent layout cell.

19. A layout cell, comprising:
layout cell information comprising information about at least one component, and a layout cell identifier identifying the layout cell, the layout cell identifier comprising at least one hash value of geometrical information about the layout cell in relation to another layout cell.

20. A method of generating a layout cell, the method comprising:
generating layout cell information comprising information about at least one component; and
generating a layout cell identifier identifying the layout cell using geometrical information about the layout cell.

21. A method of generating a layout cell arrangement, the method comprising:
generating at least one parent layout cell;
generating at least one child layout cell of the at least one parent layout cell; and
generating a layout cell arrangement identifier identifying the layout cell arrangement using geometrical information about the child layout cell.

22. The method as claimed in claim 21, wherein generating the layout cell arrangement identifier comprises determining at least one hash value of the geometrical information about the child layout cell.

23. The method as claimed in claim 22, wherein the determining the at least one hash value of the geometrical information about the child layout cell comprises:
determining a first partial hash value of the geometrical information about the child layout cell; and
determining a second partial hash value of the geometrical information about the parent layout cell and the first partial hash value.

24. The method as claimed in claim 22, wherein determining the at least one hash value is carried out using a one-way hash function.

25. The method as claimed in claim 22, wherein the at least one hash value comprises a vector having at least two dimensions.

26. A method of generating a layout cell arrangement, the method comprising:
generating at least one parent layout cell;
generating at least one child layout cell of the at least one parent layout cell; and
generating a layout cell arrangement identifier identifying the layout cell arrangement using geometrical information about the child layout cell, the at least one parent layout cell referencing the at least one child layout cell by means of a transformation operator.

27. The method as claimed in claim 26, wherein the transformation operator comprises a commutative transformation operator.

28. The method as claimed in claim 26, wherein the transformation operator comprises an associative transformation operator.

29. The method as claimed in claim 26, wherein the transformation operator comprises at least one of, a summation, an exclusive-or, or a multiplication operation.

30. A method of generating a layout cell arrangement, the method comprising:
generating at least one parent layout cell;
generating at least one child layout cell of the at least one parent layout cell; and
generating a layout cell arrangement identifier identifying the layout cell arrangement using geometrical information about the child layout cell, the at least one parent layout cell referencing the at least one child layout cell using an associative data structure.

31. A method of determining a layout cell identifier for a layout cell, comprising hashing geometrical information of the layout cell, thereby generating a hash value.

32. A computer program product of generating a layout cell, when being executed by means of a processor, the computer program product including code for
generating layout cell information comprising information about at least one component, and
generating a layout cell identifier identifying the layout cell using geometrical information about the layout cell.

33. A computer program product of generating a layout cell arrangement, when being executed by means of a processor, the computer program product including code for
generating at least one parent layout cell,
generating at least one child layout cell of the at least one parent layout cell, and
generating a layout cell arrangement identifier identifying the layout cell arrangement using geometrical information about the child layout cell, the at least one parent layout cell referencing the at least one child layout cell by means of a transformation operator.
